(19) United States
(12) Patent Application Publication
(10) Pub. No.: US 2013/0201106 A1
(43) Pub. Date: Aug. 8, 2013

(54) METHOD FOR CONTROLLING ACTIONS BY USE OF A TOUCH SCREEN

(71) Applicant: David Naccache, Paris (FR)

(72) Inventor: David Naccache, Paris (FR)

(73) Assignee: Compagnie Industrielle et Financiere D'Ingenierie "Ingenico", Paris (FR)

(21) Appl. No.: 13/817,509

(22) PCT Filed: Aug. 17, 2011
(86) PCT No.: PCT/EP2011/064164

§ 371 Date: Apr. 19, 2013

(30) Foreign Application Priority Data
Aug. 17, 2010 (FR) 1056630

(51) Int. Cl. G06F 3/033

(52) U.S. Cl. CPC G06F 3/033
USPC 345/158

(57) ABSTRACT

A method for controlling a pointer having a position determined by the position of at least one end of a member on a touch screen. An offset is inserted between the position of the pointer and that of the end of the member for driving movements of the pointer such that the end does not have to cover an object displayed on the screen in order to effectively select the object.

### CROSS-REFERENCE TO RELATED APPLICATIONS

This Application is a Section 371 National Stage Application of International Application No. PCT/EP2011/064164, filed Aug. 17, 2011, which is incorporated by reference in its entirety and published as WO 2012/022769 on Feb. 23, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure pertains to a method for controlling a pointer having a position determined by the position of at least one end of a limb on a touch screen.

Such methods are commonly used in the field of interfaces for electronic devices such as ticket-issuing terminals or again payment terminals.

### BACKGROUND OF THE DISCLOSURE

In the prior art, the position of the pointer most frequently coincides with that of the end acting on the screen which is most commonly a finger tip.

Now, in certain terminals that need to be compact, such as especially payment terminals, the touch screen is small and the objects displayed on this screen may have a surface area much smaller than the contact surface between the finger and the screen. In such a situation, it is very difficult for a user of the device to discriminate between two neighboring objects because he does not have a pointing tool that is precise enough for this purpose, and the user therefore risks frequently selecting objects different from those with which he would have wished to interact through the touch screen.

Such a lack of precision is aggravated by the fact that, as the finger approaches a screen, it increasingly masks the area towards which it is moving and ultimately covers the object or objects forming its destination so that the user must then blindly control the making of contact between his finger and the touch screen, and this is an additional source of selection error.

### SUMMARY

According to a functional aspect, an embodiment of the invention pertains to a method according to the introductory paragraph, characterized in that it includes a step for adjusting a direction and a distance of offset and a step for inserting said offset between the position of the pointer and that of said end.

An embodiment of The invention prevents the end of a limb used to steer the movements of a pointer from having to cover an object displayed on the screen in order to effectively select said object. Furthermore, since the pointer is capable of taking any shape (cross, arrow, etc) making it possible to give form to a point (the centre of the cross, the arrow head, etc), it offers a pointing precision far greater than that offered by the end of a finger.

The step for adjusting the direction and distance of the offset enables a user to configure the offset so that the steering of the pointer appears to him to be as natural as possible and therefore gives the user a customized ergonomy that minimizes the risk of selection error.

According to one particular mode of implementation of an embodiment of the invention, the step of adjusting includes a step for measuring a variation of a distance between two fingers simultaneously present on the touch screen.

According to another particular embodiment of the invention which could advantageously be used in combination with the previous one, the step of adjusting includes a step for measuring an angle between a first straight-line segment linking the ends of two fingers, of which a simultaneous presence on the touch screen is detected, and a second straight-line segment linking the ends of said fingers after one of the two has been imparted with a rotational motion relative to the other.

According to yet another particular mode of implementation of an embodiment of the invention, which could advantageously be used in combination with the preceding ones, the step for adjusting includes a step for detecting a motion in a common direction of three fingers, of which a simultaneous presence on the touch screen is detected and means for assigning said common direction to the direction of offset.

According to a specific mode of implementation, the common direction will advantageously be an essentially cardinal direction. It will thus be possible to program four potential configurations of the pointer in advance, the selection of the most relative configuration being done in choosing that cardinal direction for which the common direction is the closest.

The three modes of implementation described here above make it possible to adjust a distance and a direction of offset without requiring hardware means other than the touch screen itself. All that will be required is a special programming of the means for processing the information produced by the touch screen so that the detection of a simultaneous presence of two fingers on the screen activates an execution of the step for adjusting.

According to one particularly advantageous mode of implementation of an embodiment of the invention, a method such as the one described further above includes a step for activating a command pertaining to a zone above which the pointer is held in position by means of a first finger placed in contact with the touch screen, said step for activating including a step for detecting at least one contact of a second finger with a surface called a surface of impact of the touch screen, the nature of the command to be activated depending on the position of the surface of impact relative to the surface of contact of the first finger with the touch screen.

Such a mode of implementation takes advantage of the tactile nature of the screen to enable the entry of a command without any additional hardware means being required for this purpose. The coming into contact with the screen by the second finger whose direction activates the command could be single or multiple so as to emulate for example a “single click” or “double click” type commands known to users of personal computers.

In particular:
when the surface of impact is separated from the surface of contact by a distance appraised along a first direction, said command is a command to start execution of a program with which there is associated an icon above which the pointer is held in position by means of the first finger, and
when the surface of impact is separated from the surface of contact by a distance appraised along a second direction substantially opposite the first direction, then said command is a command for displaying a contextual menu pertaining to an object displayed in the zone above which the pointer is held in position by means of the first finger.

This mode of implementation offers functions similar to those well known to computer mouse-users as the “left click” and “right click” and therefore has optimal ergonomy.

According to one variant of the invention, a method according to the introductory paragraph is characterized in that it includes a step for detecting a simultaneous presence of two fingers on the touch screen, the step for inserting an offset being then achieved by assigning the pointer a median position between the surfaces of contact of said fingers with the screen.

This variant is remarkable by its simplicity and enables highly intuitive and therefore highly rapid adjustment of the offset.

According to one particular mode of implementation of this variant, the method described here above includes a step for activating a command pertaining to a zone above which the pointer is held in position, said step for activating including a step for detecting at least one contact of a third finger with the surface of the screen.

In such an embodiment, the position of the point of contact of the third finger relative to the image that is displayed on the screen is inoperative because the detection relates to the coming into contact of the third finger with the screen itself whatever the place at which the contact occurs provided that it takes place while two first fingers are kept in contact with the screen to position the pointer above the object to be activated.

According to a hardware aspect, an embodiment of the invention pertains to a payment terminal including a touch screen and means for displaying a pointer having a position determined by the position of one end of a limb on said touch screen, this terminal being characterized in that it includes means for adjusting a direction and a distance of offset and means for inserting an offset between the position of the pointer and that of said end, characterized in that said means for adjusting include means forming part of the following group:
means for measuring a variation of a distance between two fingers simultaneously present on the touch screen;
means for measuring an angle between a first straight-line segment linking the ends of two fingers, of which a simultaneous presence on the touch screen is detected, and a second straight-line segment linking the ends of said fingers after one of them has been imparted with a rotational motion relative to the other;
means for detecting a motion in a common direction of three fingers, of which a simultaneous presence on the touch screen is detected, and means for assigning said common direction to the direction of offset; or
means for detecting a simultaneous presence of two fingers on the touch screen, the step for inserting an offset being then achieved by assigning a pointer a median position between the surfaces of contact of said fingers with the screen.

According to yet another hardware aspect and as a means useful for its implementation, an embodiment of the invention also pertains to a computer program characterized in that it comprises program code instructions for implementing a method as described further above when this program is executed by a processor.

### BRIEF DESCRIPTION OF THE DRAWINGS

Other features and advantages shall appear more clearly from the following description of a particular embodiment, given by way of a simple, illustratory and non-exhaustive example and from the appended drawings, of which:

FIG. 1 is a functional diagram representing a communications system in which an embodiment of the invention is implemented;

FIG. 2 is a view in perspective illustrating the working of an embodiment of the invention;

FIGS. 3 and 4 are views in perspective illustrating the execution of a mode of adjustment of a distance of offset;

FIGS. 5, 6, 7 and 8 are views in perspective illustrating the execution of a first mode of adjustment of the direction of offset;

FIGS. 9, 10, 11 and 12 are views in perspective that illustrate the execution of a second mode of adjustment of a direction of offset;

FIG. 13 is a view in perspective illustrating the execution of a step for activating a command of a first type;

FIG. 14 is a view in perspective illustrating the execution of a step for activating a command of the second type;

FIGS. 15 and 16 are views in perspective illustrating the working of the invention according to one alternative embodiment.

### DETAILED DESCRIPTION OF ILLUSTRATIVE EMBODIMENTS

### 1. General Principle

The general principle of an embodiment of the invention relies on the adjustment of a direction and a distance of offset and on an insertion of said offset between the position of the pointer and that of the end of a limb serving to drive the movements of the pointer so that said end does not have to cover an object displayed on the screen in order to effectively select this object.

### 2. Description of One Embodiment

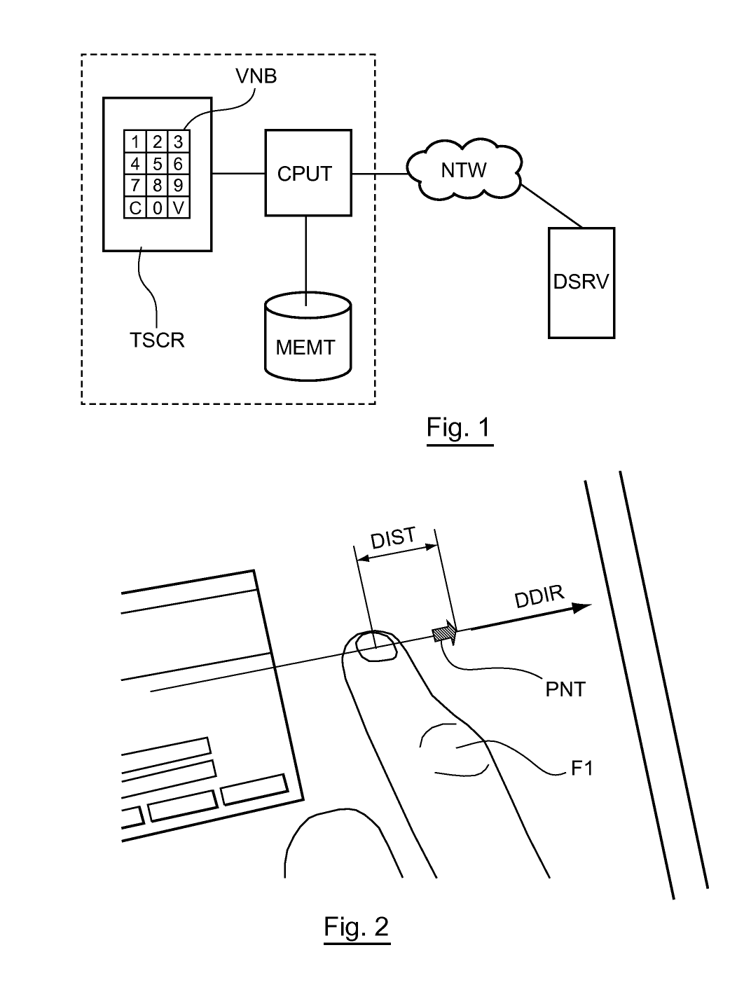

FIG. 1 represents a communications system SYST in which an embodiment of the invention is implemented. This system SYST includes a terminal RPT designed to communicate with at least one remote server DSRV by means of a communications network NTW, for example a network compliant with an Internet-type protocol. In one particularly advantageous application of an embodiment of the invention, the terminal RPT is a payment terminal while the remote server belongs to a banking organization and is meant to record a transaction defined and organized by the payment terminal RTP.

The terminal RTP is provided with a touch screen TSCR capable in particular of displaying a virtual numerical pad VNB and connected to a processor CPUT itself connected to a memory MEMT. During an initialization phase, the processor CPUT interrogates a memory MEMT in order to load, into an internal memory of said processor CPUT, a program including instructions which, when executed by said processor CPUT, will enable the method according to an embodiment of the invention to be implemented.

In particular, once this initialization has been done, the device RPT will be capable of inserting an offset between the position of a pointer displayed on the screen VNB and that of one end of a user's limb meant to drive movements of said pointer when this end is in contact with the screen.

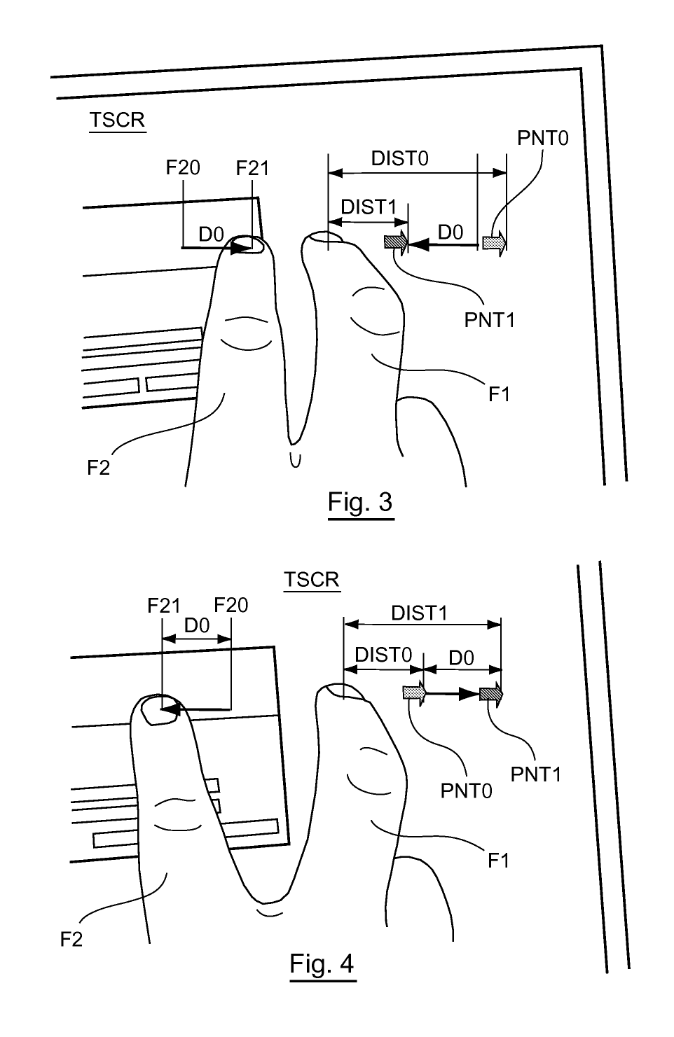

FIG. 2 illustrates a first mode of implementation of an embodiment of the invention in which the pointer PNT takes the form of an arrow, its movements being meant to be driven by the movement of the end of a finger F1 placed in contact with the touch screen TSCR. In this first mode of implementation, the insertion of an offset between the pointer PNT and the end of the finger F1 is achieved by adjusting a distance DIST and a direction of offset DDIR between the position of the pointer displayed on the screen TSCR and that of the end of the finger F1.

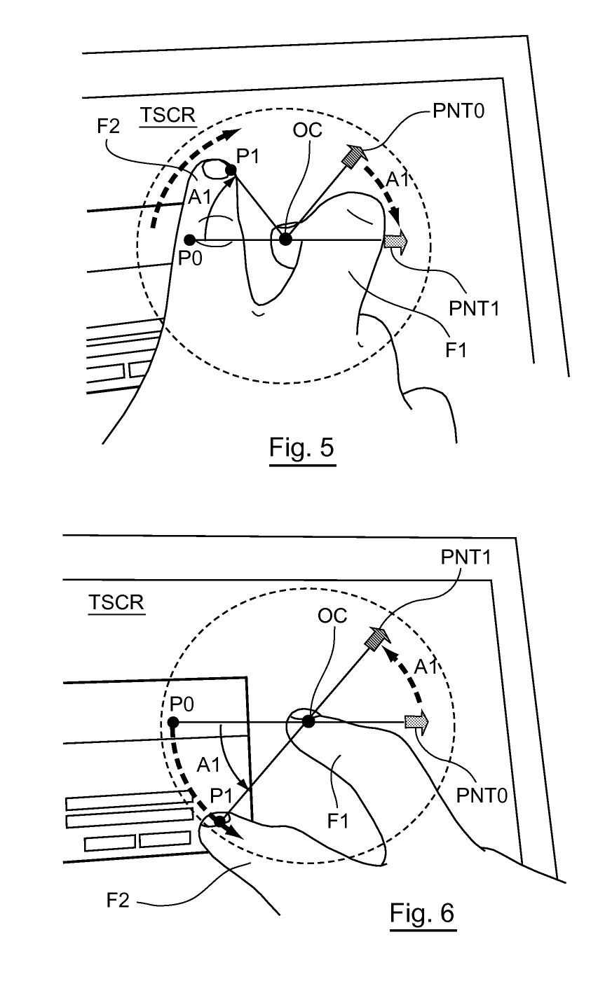

FIGS. 3 and 4 illustrate the execution of a step for adjusting the distance of offset DIST. In both cases represented here, after the device has been placed in a mode of operation called a mode of adjustment, a variation of a distance D0 between two fingers F1 and F2 simultaneously present on the touch screen TSCR is measured, this variation of distance being then in this example subtracted from an initial distance of offset DIST0 to produce a new distance of offset DIST1.

In the case illustrated in FIG. 3, the user has initially placed his first and second fingers F1 and F2, in this case his middle finger and his index finger respectively, simultaneously in contact with the touch screen TSCR. The user has then moved his index rightward, thus bringing it closer to his middle finger. As a consequence, the variation of the distance D0 between the index finger and the middle finger is considered to be positive since the movement has been done in the sense of the direction of offset referred to here above. Its subtraction from the initial distance of offset DIST0 will therefore prompt a reduction in the distance of offset DIST1, the pointer then passing from a position PNT0 to a position PNT1 closer to the end of the finger F1.

In the case illustrated by FIG. 4, the user has initially and simultaneously placed first and second fingers, in this case his middle finger and his index finger, respectively in contact with the touch screen TSCR. The user has then moved his index rightward, thus moving it away from his middle finger. As a consequence, the variation of the distance D0 between the index and the middle finger is considered to be negative since the movement has been done in a sense opposite the direction of offset referred to here above. Its subtraction from the initial distance of offset DIST0 will therefore give rise to an increase in the distance of offset DIST1, the pointer then going from a position PNT0 to a position PNT1 that is further away from the finger F1.

The mode of adjusting the distance of offset illustrated by FIGS. 3 and 4 is thus highly intuitive and therefore particularly ergonomical since a reduction of the distance between the first and second fingers F1 and F2 will cause a further reduction of the distance of offset while an increase in the distance between the first and second fingers F1 and F2 will increase the distance of offset.

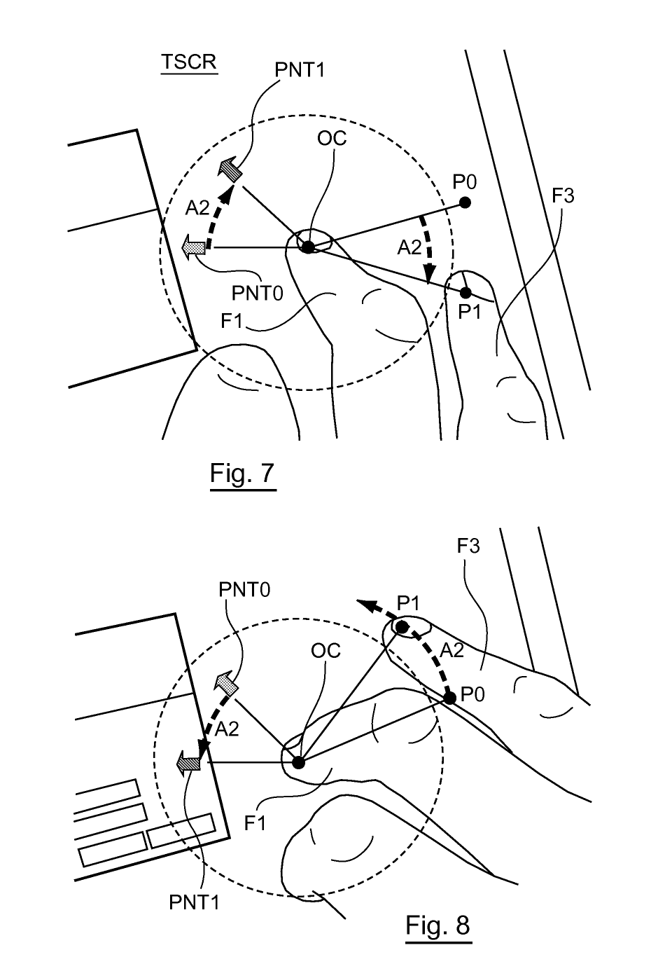

FIGS. 5, 6, 7 and 8 are views in perspective that illustrate the execution of a first mode of adjusting the distance of offset which provides for a measurement of an angle between a first straight-line segment [OC; P0] linking the ends of two fingers, of which a simultaneous presence on the touch screen is detected, and a second straight-line segment [OC; P1] linking the ends of said fingers after one of them has been imparted with a rotational motion relative to the other.

FIGS. 5 and 6 each illustrate a case where the fingers used to adjust the direction of offset are the user's middle finger F1 and the index finger F2. In each of these cases illustrated here, the user has initially placed his middle finger F1 and his index finger F2 simultaneously in contact with the touch screen TSCR in two positions respectively denoted as OC and P0. The user has then made his index finger F2 pivot relative to his middle finger to make it occupy a position P1, the position OC of the middle finger remaining unchanged. This motion will enable an angle A1 to be defined between a first straight-line segment [OC; P0] linking the end of the middle finger F1 and that of the index finger F2 in its initial position P0 and a second straight-line segment [OC; P1] linking the end of the middle finger F1 and that of the index finger F2 in its position of arrival P1. This angle A1 is then added to the angle which previously defined the direction of offset of the pointer PNT0, the direction of offset being thus modified as can be seen by the new orientation of the pointer PNT1 resulting from this adjustment.

As can be seen respectively in FIGS. 5 and 6, a clockwise rotation of the index finger relative to the middle finger causes a clockwise rotation of the direction of offset while a counter-clockwise rotation of the index relative to the middle finger causes a counter-clockwise rotation of the direction of offset, making this mode of adjustment of the direction of offset highly intuitive and ergonomical.

FIGS. 7 and 8 each illustrate a case where the fingers used for adjusting the direction of offset are the user's middle finger F1 and ring finger F3. In each of the cases illustrated here, the user has initially placed his middle finger F1 and his ring finger F3 simultaneously in contact with the touch screen TSCR in positions respectively denoted as OC and P0. The user has then made his ring finger F3 pivot relative to his middle finger F1 to make it occupy a position P1, the position OC of the middle finger remaining unchanged. This movement will have enabled an angle A2 to be defined between a first straight-line segment [OC; P0] linking the end of the middle finger F1 and that of the ring finger F3 in its initial position P0 and a second straight-line segment [OC; P1] linking the end of the middle finger F1 and that of the ring finger F3 in its position of arrival P1. This angle A2 has then been added to the one previously defining the direction of offset of the pointer PNT0, the direction of offset being thus modified as can be seen in the new orientation of the pointer PNT1 resulting from this adjustment.

As can be seen respectively in FIGS. 7 and 8, a clockwise rotation of the ring finger relative to the middle finger causes a clockwise rotation of the direction of offset while a counter-clockwise rotation of the ring finger relative to the middle finger causes a counter-clockwise rotation of the direction of offset, thus making this mode of adjustment of the direction of offset also highly intuitive and ergonomical.

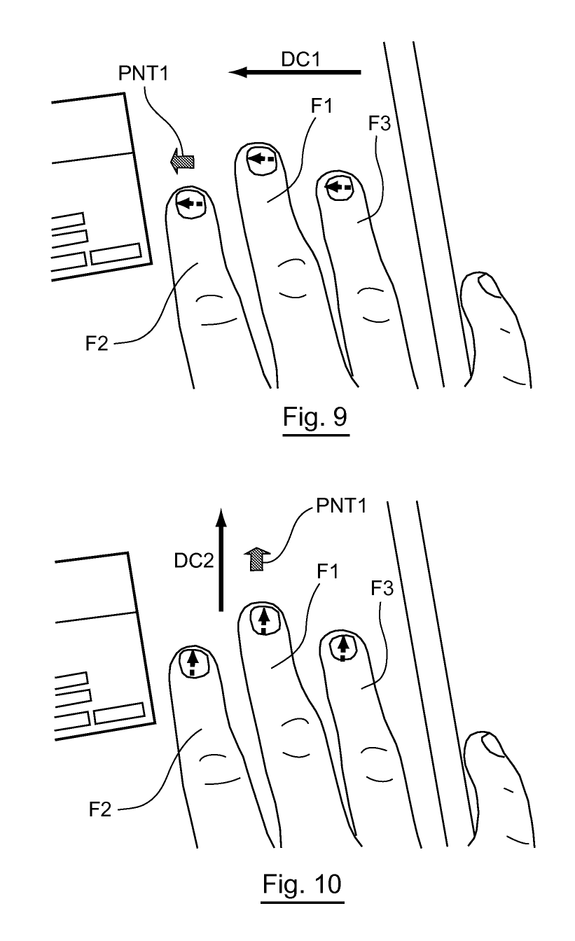

FIGS. 9, 10, 11 and 12 are views in perspective each illustrating the execution of a second mode of adjustment of the direction of offset which provides for a detection of a motion in a common direction of the three fingers F1, F2 and F3, of which a simultaneous presence on the touch screen is detected, and means for assigning said common direction to the direction of offset conveyed to the pointer PNT1.

In the specific embodiment represented by FIGS. 9, 10, 11 and 12, the direction to be conveyed to the pointer PNT1 is an essentially cardinal direction DC1, DC2, DC3 or DC4 respectively. It is thus possible to program four potential configurations of the pointer PNT1 in advance, the selection of the most relevant configuration being done by choosing that cardinal direction DC1, DC2, DC3 or DC4 for which the direction of motion common to the three fingers F1, F2 and F3 is the closest.

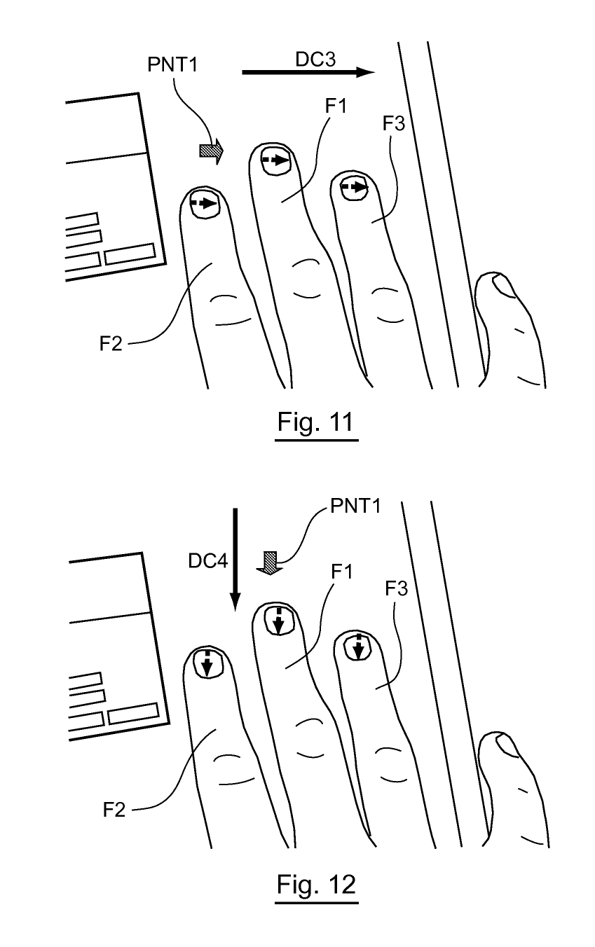

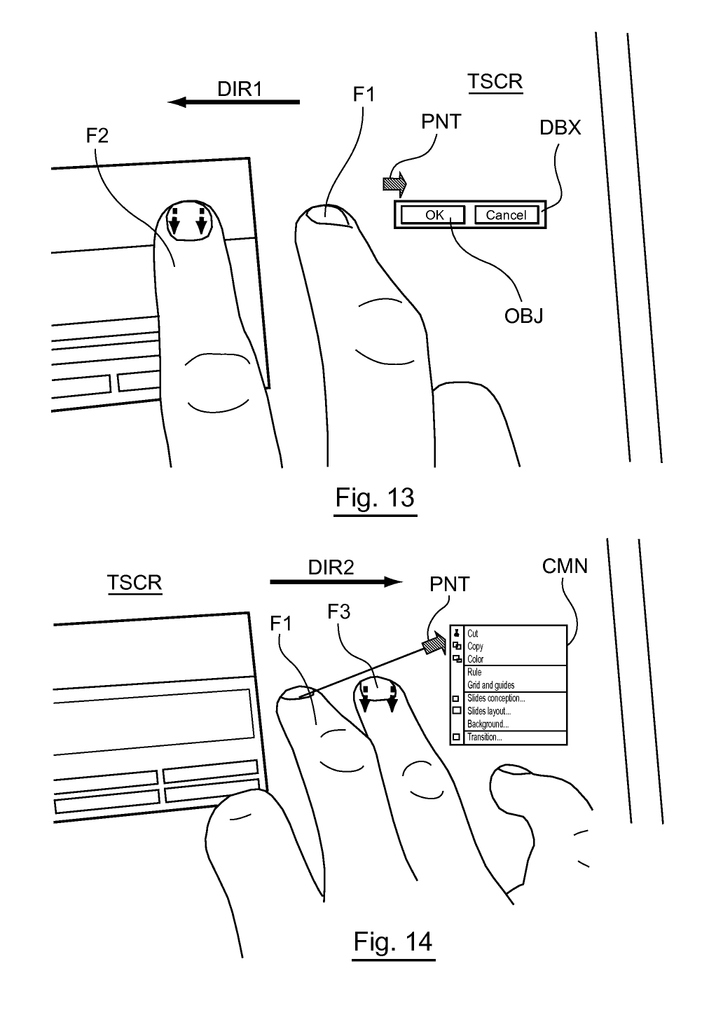

FIGS. 13 and 14 are views in perspective each illustrating the execution of a step for activating a command relative to a zone of the touch screen TSCR representing an object OBJ above which the pointer PNT is held in position by means of a first finger F1 placed in contact with the touch screen TSCR while the device according to an embodiment of the invention is in an operational mode of functioning.

In the cases illustrated by FIGS. 13 and 14, the step for activating includes a step for detecting at least one contact of a second finger F2 or F3 with a surface called a surface of impact of the touch screen TSCR, this temporary contact being graphically represented in the form of two vertical arrows plotted with dashes. In the modes of implementation illustrated here, the nature of the command to be activated depends on the position of the surface of impact relative to the contact surface of the first finger F1 with the touch screen TSCR.

FIG. 13 illustrates a case where the surface of impact is separated from the contact surface by a distance appraised along a first direction DIR1 in which case the command to be activated is a command for starting the execution of a program with which there is associated an icon above which the pointer is held in position by means of the first finger, in this case a button “OK” of a dialog box DBX.

FIG. 14 illustrates a case where the surface of impact is separated from the contact surface by a distance appraised along a second direction DIR2 substantially opposite the first direction DIR1 in which case the command to be activated is a command for displaying a context menu CMN pertaining to an object displayed in the zone above which the pointer PNT is held in position by means of the first finger F1. The user could then, in keeping his finger F3 in contact with the screen TSCR, make the pointer PNT move in the contextual menu by means of the first finger F1 in order to make a selection of one of the options offered by this contextual menu CMN.

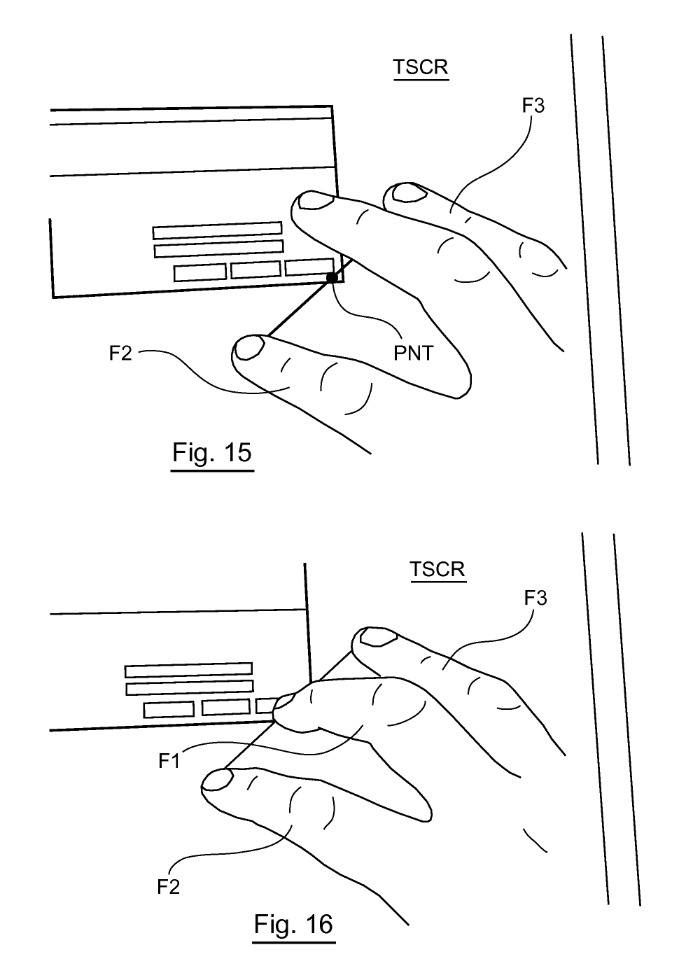

FIG. 15 illustrates an alternative embodiment of the invention which provides for a step for detecting a simultaneous presence of two fingers F1 and F3, in this case respectively the index finger and the ring finger of the same hand, on the touch screen TSCR, the step for inserting an offset being then obtained by assigning the pointer PNT a median position between the surfaces of contact of said fingers F2 and F3 with the screen TSCR.

This variant is remarkable by its simplicity and permits a highly intuitive and therefore very swift adjustment of the offset.

FIG. 16 illustrates a particular mode of implementing this variant which includes a step for activating a command relative to a zone above which the pointer is held in position, said step for activating including a step for detecting at least one contact of a third finger F1 with the surface of the screen TSCR.

In an embodiment of this kind, the position of the point of contact of the third finger F1 relative to the image displayed on the screen is inoperative because the detection relates to the contact of the third finger with the screen itself, whatever the place at which this contact occurs, provided that it takes place while the first two fingers are kept in contact with the screen to position the pointer above the object to be activated.

Thus, although in the situation illustrated here, the index finger F2 and the ring finger F3 together define the position of the pointer while the third finger F1 whose contact with the screen is detected by the middle finger. In other situations, the finger whose contact with the screen will be detected could be the thumb or again the ring finger or even a finger of another hand thus leaving the pointer totally uncovered and therefore visible during the execution of the step for activating.

The contact with the screen of the third finger whose detection will cause the activation of the command could be single or multiple to emulate for example the “single click” or “double click” type commands known to users of personal computers.

An exemplary embodiment of the present disclosure provides a method for controlling a pointer enabling it to be assigned a position that does not coincide with the position of the end of the limb that determines the position of the pointer on the touch screen.

Although the present disclosure has been described with reference to one or more examples, workers skilled in the art will recognize that changes may be made in form and detail without departing from the scope of the disclosure and/or the appended claims.

1. A method comprising:
controlling a pointer having a position determined by the position of at least one end of a limb on a touch screen, comprising adjusting a direction and a distance of offset and inserting said offset between the position of the pointer and that of said end, wherein adjusting includes at least one of the following steps:
a step of measuring a variation of a distance between two fingers simultaneously present on the touch screen;
a step of measuring an angle between a first straight-line segment linking the ends of two fingers, of which a simultaneous presence on the touch screen is detected, and a second straight-line segment linking the ends of said fingers after one of the two has been imparted with a rotational motion relative to the other;
a step of detecting a motion in a common direction of three fingers, of which a simultaneous presence on the touch screen is detected, and a step of assigning said common direction to the direction of offset; or
a step of detecting a simultaneous presence of two fingers on the touch screen, the step for inserting an offset being then achieved by assigning the pointer a median position between the surfaces of contact of said fingers with the screen.

2. The method according to claim 1 wherein, when said step of adjusting includes a step of detecting a motion of three fingers in a common direction, said common direction is essentially cardinal.

3. The method according to claim 1, wherein the method includes a step of activating a command pertaining to a zone above which the pointer is held in position by a first finger placed in contact with the touch screen, said step of activating including a step of detecting at least one contact of a second finger with a surface called a surface of impact of the touch screen, a nature of the command to be activated depending on the position of the surface of impact relative to the surface of contact of the first finger with the touch screen.

4. The method according to claim 3, wherein:
when the surface of impact is separated from the surface of contact by a distance appraised along a first direction, said command is a command to start execution of a program with which there is associated an icon above which the pointer is held in position by the first finger, and
when the surface of impact is separated from the surface of contact by a distance appraised along a second direction substantially opposite the first direction, then said command is a command for displaying a contextual menu pertaining to an object displayed in the zone above which the pointer is held in position by the first finger.

5. The method according to claim 1 wherein, when the step of inserting an offset is achieved by assigning the pointer a median position between the surfaces of contact of two fingers simultaneously present on the screen, the method includes a step of activating a command pertaining to a zone above which the pointer is held in position, said step of activating including a step of detecting at least one contact of a third finger with the surface of the screen.

6. A computer-readable memory comprising a computer r program stored thereon, which comprises program code instructions for implementing a method, when this program is executed by a processor, wherein the instructions comprise:
instructions configured to cause the processor to control a pointer having a position determined by the position of at least one end of a limb on a touch screen, with steps comprising adjusting a direction and a distance of offset and inserting said offset between the position of the pointer and that of said end, wherein adjusting includes at least one of the following steps:
measuring a variation of a distance between two fingers simultaneously present on the touch screen;
measuring an angle between a first straight-line segment linking the ends of two fingers, of which a simultaneous presence on the touch screen is detected, and a second straight-line segment linking the ends of said fingers after one of the two has been imparted with a rotational motion relative to the other;
detecting a motion in a common direction of three fingers, of which a simultaneous presence on the touch screen is detected, and a step of assigning said common direction to the direction of offset; or
detecting a simultaneous presence of two fingers on the touch screen, the step for inserting an offset being then achieved by assigning the pointer a median position between the surfaces of contact of said fingers with the screen.

7. A payment terminal comprising:
a touch screen;
means for displaying a pointer having a position determined by the position of one end of a limb on said touch screen;
means for adjusting a direction and a distance of offset; and
means for inserting the offset between the position of the pointer and that of said end, wherein said means for adjusting include at least one of:
means for measuring a variation of a distance between two fingers simultaneously present on the touch screen;
means for measuring an angle between a first straight-line segment linking the ends of two fingers, of which a simultaneous presence on the touch screen is detected, and a second straight-line segment linking the ends of said fingers after one of them has been imparted with a rotational motion relative to the other;
means for detecting a motion in a common direction of three fingers, of which a simultaneous presence on the touch screen is detected, and means for assigning said common direction to the direction of offset; or
means for detecting a simultaneous presence of two fingers on the touch screen, the step for inserting an offset being then achieved by assigning a pointer a median position between the surfaces of contact of said fingers with the screen.
